(19) United States
(12) Patent Application Publication
(10) Pub. No.: US 2006/0248762 A1
(43) Pub. Date: Nov. 9, 2006

(54) Tactile guidance means

(76) Inventor: Jacquline Anne Moore, Derbyshire (GB)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/537,654

(22) PCT Filed: Dec. 3, 2003
(86) PCT No.: PCT/GB03/05213

§ 371 Date: May 9, 2006

(30) Foreign Application Priority Data
Dec. 5, 2002 (GB) 0228380.2

(51) Int. Cl. G09F 7/00

(52) U.S. Cl. 40/584

(57) ABSTRACT

A tactile guidance means (1) capable of being provided as part of or affixed to a supporting medium, said means provided with a first type of distinctive raised or indented tactile feature, said tactile features being capable of tactile interrogation when contacted by a sensory part of a person using the same for guidance provided to identify a doorway or passage to a user through which to proceed. Typically a second form of tactile features are provided to indicate a direction to the user in which to proceed subsequent to proceeding through said doorway or passage.

The present invention relates to a tactile guidance doorplate to allow a user to identify a door, doorway, passage, corridor or the like and generally a safe passage which would lead to a route within a building, means of transport, or premises in conditions of low light or poor visibility. The route can be to an exit, collection point, emergency equipment or any predetermined location as required.

The use of directional signs such as exit signs are well known and are an adopted method of directing people towards stairways and safe exit points during everyday use and in the case of an emergency, such as in the event of a fire. These signs are generally in the form of a visual aid, such as an image or text.

A problem associated with visual aids is that they rely on a person exiting the building, means of transport or premises to either see or understand the language of the text or the image on the sign. In addition, although exit signs are often illuminated to assist safe exit in low light situations, the signs are not useful for blind or visually impaired people and those with poor eyesight. In certain situations, such as in dense smoke, signs become quickly obscured and are not useful to people with normal vision.

It is also known to provide guidance rails which can be followed by a person and which rails can include tactile features provided thereon which allow the user to follow the same in a particular direction to follow an exit route. It is also known to provide as part of said rails an indication of when a doorway is reached by providing a different shape of tactile device. While these rail systems are found to be extremely helpful, the present invention provides a further advantageous solution to the problem of the provision of directional information to a user in times of emergency by providing a typically unitary member or plate at a particular location which can provide directional information without the need for a guide rail to depend therefrom.

In prior art various plates are known for protecting the surface coating of the door from mechanical abrasion, soiling and other degradation, or to provide decorative addition. However, none are provided to allow directional information to be passed to a person in a tactile manner.

It is therefore an aim of the application to provide a direction indicating device to a person or persons within a premises, vehicle or other environment and which device includes tactile features for imparting the information to the user. It is a further aim of the present invention to provide a doorplate or area that can be accommodated and accepted in a plurality of applications and one that is aesthetically pleasing and acceptable and may be readily incorporated within existing or newly constructed applications and which can preferably be used to assist blind or visually impaired people to navigate their way along a particular route in a non-emergency situation.

According to a first aspect of the present invention there is provided a tactile guidance means to provide guidance to a person, said tactile guidance means having a plurality of tactile features for tactile interrogation when in contact with a sensory part of the person, and characterised in that said tactile features are provided in a first form to identify a doorway or passage location through which the person should proceed, and at least a second form to indicate a direction to be followed subsequent to passing through said doorway or passage.

Typically the tactile guidance means comprises a plurality of raised or indented features in a first form located at a pre-determined area with the means located on a door surface to identify the door and hence doorway through which to proceed by the user to a particular location, the user identifying the correct door by feeling the tactile guidance means by using a sensory part of their body, and wherein one or more tactile indicators are provided in at least a second form on the said surface, the tactile indicators in said at least second form indicating to a user that they are required to proceed in a particular direction after moving through the doorway in order to reach said particular location.

Typically, if the route to be followed after going through the doorway incorporates a turn or change in direction or continuation of the current direction, the tactile indicators in said at least second form are located such that the user feels the first form of indicators to identify the correct door and encounters the second form of indicators which provide a directional indication matching the required direction to be followed. The directional indication may also be provided to allow the person to make contact with further tactile guidance means.

Preferably the tactile indicators of said first form have one or more features which are clearly and easily distinguishable from the tactile indicators of said at least second form.

In one embodiment the identification of the correct door, doorway or passage involves the user making contact with the first form of tactile indicators on the surface of the guidance means. Typically the persons in the environment in which the means are provided are aware of the particular height of the means prior to an emergency situation so can undertake informed searches for the same.

Although reference is hereonin made to the provision of a plate it should be appreciated that the plate can be provided to be affixed to the door, wall or support medium or may instead be provided as an integral part of the structure or, yet further the tactile indicators may be directly attached or provided in the support medium with a plate, in the required configuration to provide the required directional information and all of these embodiments are incorporated in the scope of this invention. Thus the suitable supporting medium or mounting medium can be in the form of a material which is adapted to be secured to, or be an integral part of a surface of a door, handrail, wall, structure or building.

In one embodiment the second form of tactile indicators includes an indicator as to the required direction or change of direction to be made in which to proceed once immediately through the door, for example turn right after going through the door.

Preferably the tactile indicators in said first and at least second forms are provided, where possible, on the surface of the doors along the route of travel/movement required to reach the particular location from any other predetermined location.

Preferably the surface on which the tactile indicators are provided is any or any combination of door surface, handrail surface, wall surface, structure surface, building surface or mounting medium attachable to, or integral part of, any of the aforementioned surfaces. The indicators can be provided at any or any combinations of height or position on the surface.

Preferably securing means for securing the mounting medium to a surface can be any or any combination of adhesive, clips, screws, nuts and bolts and/or the like.

The door, handrail or structure surface are typically provided in a building, premises or means of transport and the particular location therein is typically an exit.

Preferably the tactile indicators of said first and at least second from differ in any or any combination of shape, texture, size, orientation, spatial arrangement and/or the like.

Preferably the tactile indicators are in the form of raised protrusions or indents or holes on said surface in any suitable shape. The protrusions or indents or holes can be embossed, machined or moulded on or in the surface or suitable medium mounted on the surface.

In one embodiment the first form of tactile indicator is in the form of a dome shape. The at least second form of tactile indicator is in the form of a tapered shape having an inclined surface, the direction of the incline indicating to the user the correct direction to travel once through the door (typically the incline is from a low point to a high point relative to the surface in the direction of movement).

In a further embodiment, a plurality of tactile indicators indicate a set of instructions for movement. For example, the tactile guidance plate can be provided with a first form of tactile indicator in a dome shape, a second form in a tapered shape with an inclined surface indicating a rightward direction, a third form in a cube shape to indicate forward movement and a further second form located underneath the third form indicating a leftward direction. Thus the user would be instructed to pass through the doorway, turn right, move forward and turn left to reach an exit or next tactile guidance plate.

In an alternative embodiment, the number of tactile indicators in a particular spatial arrangement, shape, orientation, texture or size on the tactile guidance plate may indicate the distance to travel to reach an exit or next tactile guidance plate. For example, the tactile guidance plate could be provided with a plurality of second forms in a tapered shape with an inclined, surface indicating a rightward direction, the number of tactile indicators indicating the distance to proceed in said direction.

In one embodiment the shape of the tactile indicators indicate the direction of movement visually, for example an arrow shape.

Preferably the sensory part of the user's body used to feel the tactile indicators is a hand, foot, arm, leg and/,or the like.

Preferably the tactile guidance doorplates are provided with illumination means to improve the visibility and orientation of the indicators to a user in low light conditions or darkness. Such illumination means could be by way of photoluminescent materials, electroluminescent lamps, light emitting diodes, tritium gas lighting devices or the like. Such illumination means may be employed to illuminate all of the tactile guidance doorplate or area of the door, or may illuminate specific sections thereof. In this case, the tactile guidance doorplate may be manufactured from a translucent or transparent material whereby the light source would be applied or positioned adjacent to the back face of the tactile guidance doorplate and be visible therethrough. It may also be manufactured from an opaque material and a coating of phosphorescent material applied to the surface.

In one further aspect of the invention, there is provided a tactile guidance means situated adjacent a doorway or passage through which a person is to pass, said means including a first tactile form to indicate the presence of the doorway or passage and that the user should pass through the same and a second tactile form to indicate the direction to be followed by the person having gone through said doorway or passage.

Typically the tactile guidance means are raised, indented or otherwise distinguished from the adjacent surface.

In one embodiment the guidance means is attached to or provided on a door which closes the doorway or passage through which the person is indicated to pass by the guidance means. Alternatively the guidance means is attached to or provided on a support medium adjacent the doorway or passage.

In a further aspect of the invention there is provided a tactile guidance means to provide guidance to a person, said tactile guidance means having at least one tactile feature for tactile interrogation when in contact with a sensory part of the person, and said at least one tactile feature is provided in a first form to identify a doorway or passage location through which the person should proceed and characterised in that said guidance means is attached to or provided on a door which is positioned at the doorway or passage through which the person is indicated to pass by said first form of tactile features.

Typically the guidance means include a second form of tactile features which indicate a direction to be followed once the person has passed through the doorway or passage.

In one example of use it would be particularly helpful to a visually disabled person if the tactile guidance means imparts information as to the effectiveness or appropriateness of using a particular door in certain situations. For instance, were a blind or visually impaired person (or a person who is rendered blind or visually impaired by ambient conditions or circumstance such as the presence of smoke or noxious and irritant fumes) to arrive at a door, it would be of the utmost importance to be able to identify by touch whether that door constituted a door which was part of, or in whole, an exit route.

Furthermore, it is of benefit that the user is able, again by tactile interrogation, to determine in which direction to proceed after passing through the door and so aid an effective evacuation.

In a yet further aspect of the invention there is provided a method of directing a person by tactile guidance including the steps of:
providing a tactile guidance means having a plurality of tactile features for tactile interrogation;
contacting a first form of tactile feature provided to identify a doorway or passage through which the person is to move;
contacting at least a second form of tactile feature to indicate a direction to be followed subsequent to passing through said doorway or passage; characterised by
proceeding through said doorway;
and proceeding in a direction as indicated by said at least second form

The advantage of the present invention is that the tactile indicators of said at least first and second forms allow the user to be informed that the door is to be used to reach a particular location. The user may also be informed of the direction or change in direction of travel which they are required to make after immediately passing through the door to reach a particular location.

An embodiment of the present invention will now be described below with reference to the following figures, wherein:

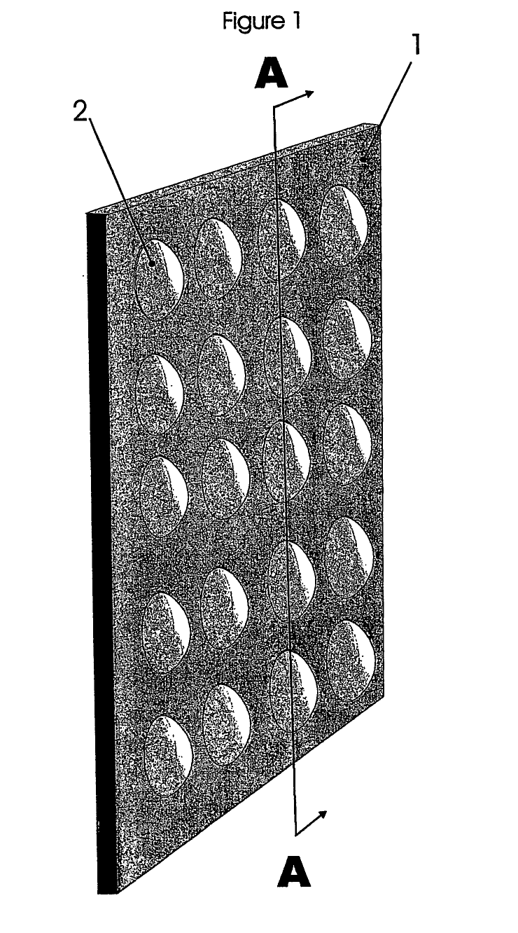

FIG. 1 shows a perspective view of the tactile guidance doorplate with tactile indicators of a first form according to an embodiment of the present invention.

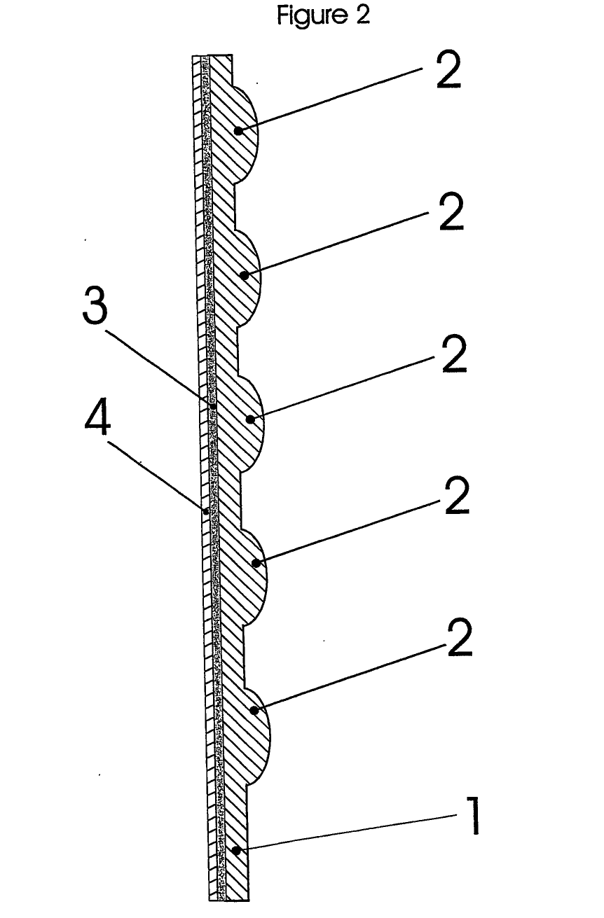

FIG. 2 shows a cross-sectional view along the line A-A of FIG. 1.

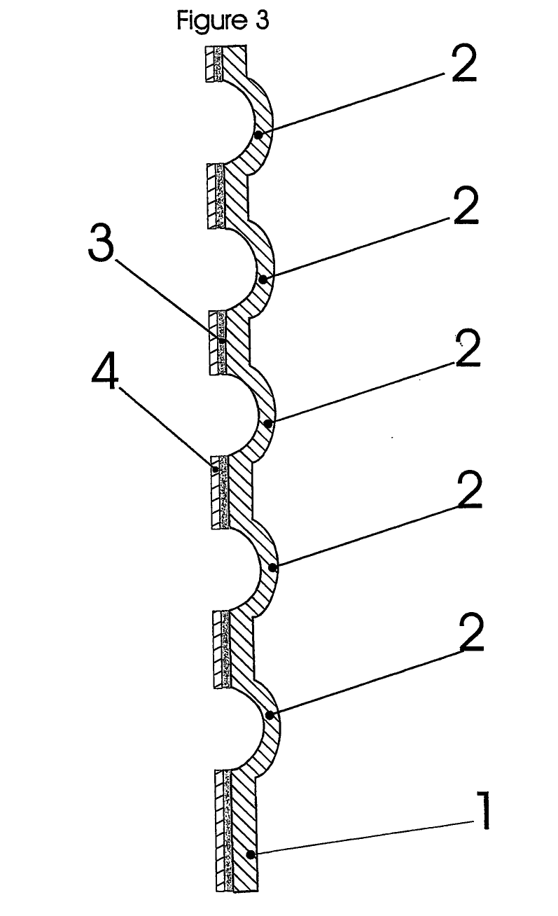

FIG. 3 shows a cross-sectional view along the line A-A of FIG. 1 in an alternative manufactured embodiment.

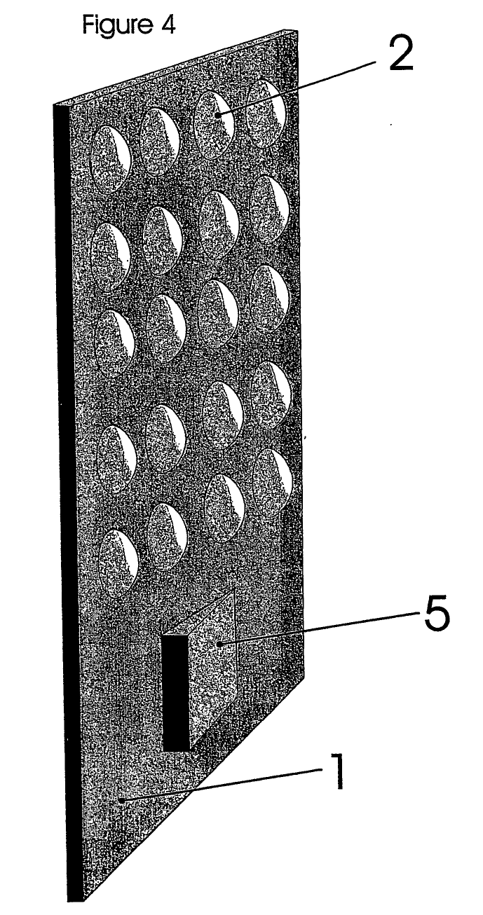

FIGS. 4-6 show a perspective view of a tactile guidance doorplate with tactile indicators of a first form and a tactile indicator of a second form for indicating the direction or change of direction to be made by the user.

FIG. 7 shows an exploded view of a tactile door guidance plate according to an embodiment of the present invention.

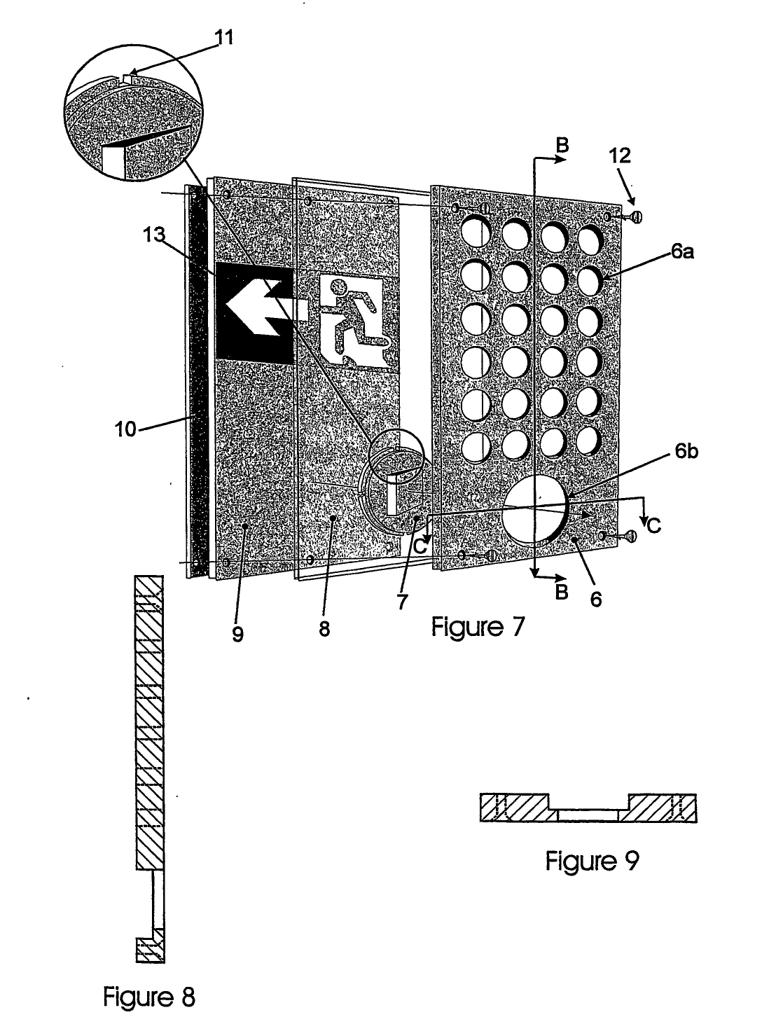

FIG. 8 shows a cross-sectional view along the line B-B of FIG. 7.

FIG. 9 shows a cross-sectional view along the line CC of FIG. 7.

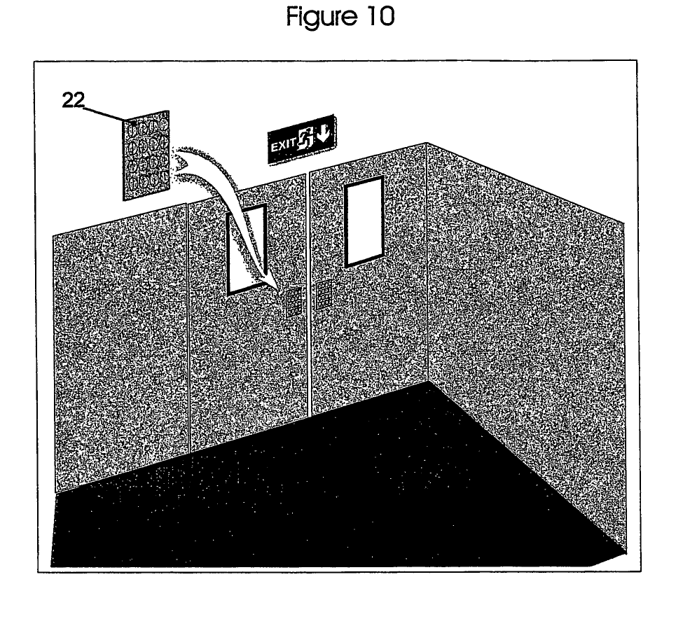

FIG. 10 shows a typical location of tactile guidance doorplates on a set of fire doors.

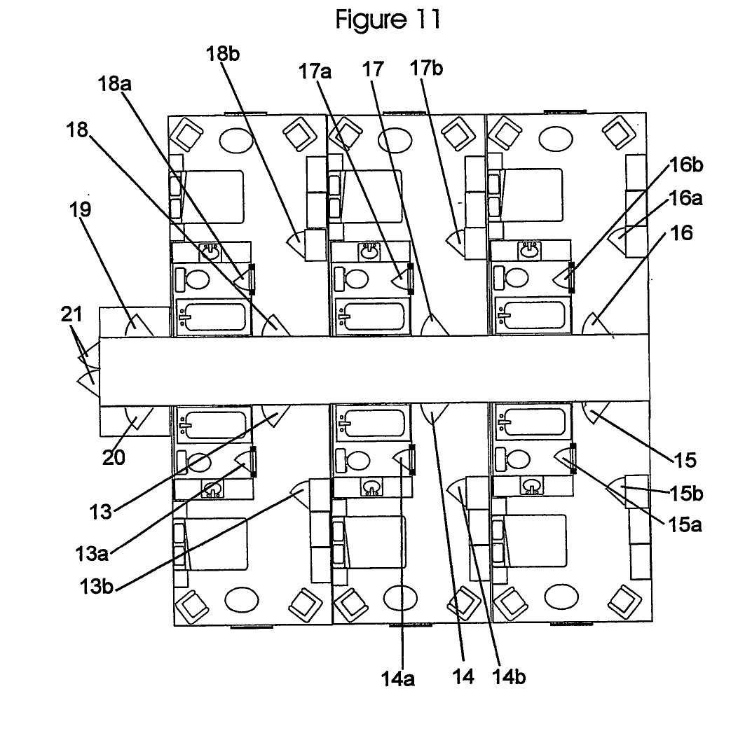

FIG. 11 shows a plan view to illustrate the application of a tactile guidance doorplate for guiding a user to an emergency exit in a hotel building. The tactile guidance doorplate is typically provided on substantially all doors which lead to or along a fire evacuation route in the hotel building to guide a user located in any part of the hotel building to the nearest emergency exit.

The tactile guidance door means in accordance with the invention is provided for persons (who may or may not be visually impaired) within a building who need to be guided to an escape or exit from said building. The guidance means comprises first tactile features in the form of raised members 2 in the form of a plurality of raised dome shapes as shown in FIG. 1 and in one embodiment of the invention only the first form of tactile features are provided so as to indicate to the persons the existence and location of a doorway or passage. Typically the guidance means are mounted on a door which closes the doorway or passage or can be mounted adjacent thereto. A further embodiment of the present invention comprises the first raised members 2 and second raised member 5 in the form of a sloped shape as shown in FIG. 4. The first and second members 2, 5 are provided fixed to supporting medium 1 as shown in FIG. 1 as a plate which can then be provided on any suitable surface such as a door, handrail and/or the like. Alternatively the features can be attached or positioned directly onto the door, handrail, wall or the like.

Referring to FIG. 1, the suitable supporting medium is seen as a backing plate 1. It is also seen that raised members 2 are of such a form, spacing and shape that they pose no risk of causing harm or discomfort during tactile interrogation by the user.

With reference to FIG. 2, the backing plate 1 and raised members 2 are of solid construction in a transparent material which has been manufactured by a process such as, but not limited to, casting. Illumination is provided in this embodiment by means of photoluminescent material 3 applied to the back surface of backing plate 1. Pressure sensitive adhesive 4 is applied to the back surface of photoluminescent material 3.

Referring now to FIG. 3 the present invention is, in this embodiment, formed by a process such as embossing or vacuum forming and may be either an autonomous entity or form part of the fabric or construction of the door, door veneer or constituent material thereof. In the case of a non-autonomous and separate entity, illumination is provided in this embodiment by means of a photoluminescent material 3 applied to the back surface of backing plate 1. The pressure sensitive adhesive 4 is applied to back surface of the photoluminescent material 3. In this case the material used in manufacture would necessarily be transparent to allow the photoluminescent material to be visible.

Referring to FIG. 4 in this embodiment the second member 5 gives additional tactile information. In order for a user to determine the correct direction in which to proceed after passing through the door, the user is required to move their hand over the second member 5. The slope of member 5 indicates the direction of correct travel to the user. In FIG. 4 the correct direction of travel after passing through the door would be to the left.

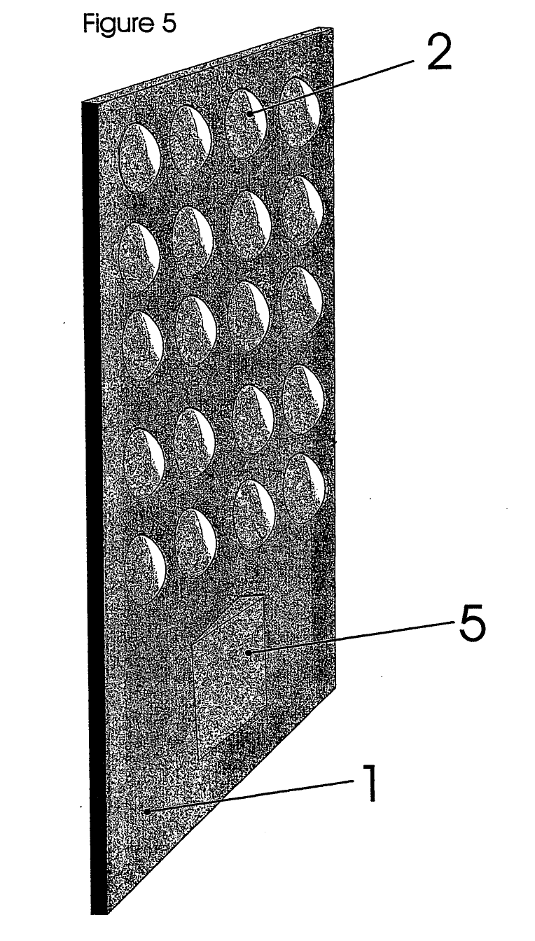

FIG. 5 shows a further embodiment of the present invention. In this embodiment, the raised member 5 guides the user to turn right after passing through the door.

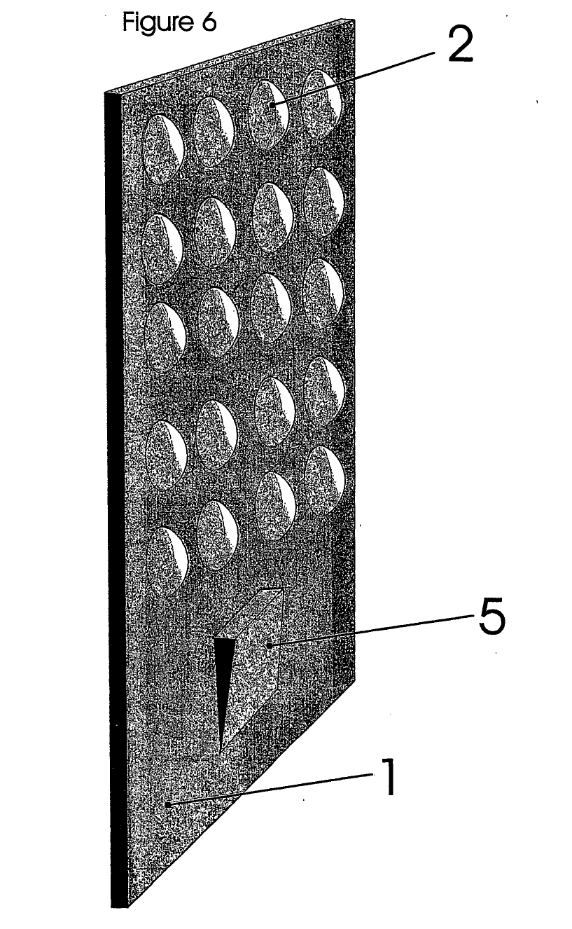

FIG. 6 shows a further embodiment of the present invention. In this embodiment, the raised member 5 informs the user that the correct direction of travel after passing through the door is straight ahead.

FIG. 7 shows an alternative tactile pattern and an alternative method of incorporating the tactile members informing the user of the direction in which to progress after passing through the door. In this embodiment the plate 6 has 24 round holes 6a drilled or otherwise machined or formed. These holes extend through the plate. In this illustration the holes are parallel as if formed by a drill. They could be otherwise shaped, for instance being tapered from a larger diameter on the front face of the plate to a smaller diameter on the back surface of the plate, that surface which adjoins sheet material 7. The holes are not restricted to a circular geometry and may for instance be square or hexagonal or other shape. In this embodiment the tactile indicators 6a are uniformly spaced and form the primary tactile pattern which identifies the door as an exit door. It may well be that these holes are not uniform in spacing, geometry or shape or formation as long as they are a singular or plurality of shapes and forms that the person, who is performing the tactile interrogation can interpret as a distinguishing feature. Plate 6 has a further feature in this illustration. Circular hole 6b passes all the way through the plate. This hole is counterbored such that the tactile direction indicator 7 may be fitted into the hole. This counterbore has a locating spigot such that slot 11 in the tactile direction indicator 7 locates and prevents the tactile direction indicator from rotating once the unit is assembled. In this embodiment a single locating feature is depicted. It is possible that this function can be achieved in other ways such as mating splines or altering the mating geometry of tactile direction indicator 7 and hole 6b to, for instance, mutually square. The tactile direction indicator 7 may be produced in many ways such as, but not limited to, casting, machining, injection moulding or vacuum forming. This tactile direction indicator may be rotationally positioned within the mating hole to correctly imply the direction in which to progress after passing through the door. It is envisaged that the thickness and depths of materials and counterbores are such that the front and back surfaces of the tactile direction indicator 7 are flush with the respective front and back faces of plate 6. Illumination of the assembly in this embodiment is by way of photoluminescent material 9, it may however be substituted for an alternative light source such as an electroluminescent panel, edge lit material or other means of illumination such as light emitting diodes, tritium gas lighting devices or the like. In this embodiment, photoluminescent material 9 is protected from wear, dirt, mechanical damage and the like by a transparent sheet material 8, such as, but not limited to, polycarbonate. If either the plate 6 or tactile direction indicator 7 were produced in a transparent material, an instruction or information legend 13 may be included by for instance screen printing or adhesive vinyl applied or affixed to the surface of the photoluminescent sheet material 9. Other sites are equally possible and viable such as on the surface of sheet material 8 or on plate 6 and/or the like. Plate 10 is a backing plate comprising of a suitable material such as, but not limited to, aluminium. The assembly is affixed to the door in this embodiment by screws 12. Front plate 6 and tactile direction indicator 7 may be of a translucent, transparent or opaque material and the assembly may comprise of either all the components or one or more as deemed appropriate. For instance, should it be deemed that a form of illumination is not required in a certain application, it may be deemed appropriate to fit only plate 6 and tactile direction indicator 7 using screws 12. Again certain applications may be more suited to a different method of fixing such as adhesive.

It is intended that the provision of a source of illumination, such as photoluminescent material, will assist in the safe use of this present invention. For instance in a situation where the emergency lights have failed or are rendered inefficient by overhead smoke, the glow from photoluminescent material would lead people to the correct door. Referring again to FIG. 7, in this embodiment, the photoluminescent material is a separate component of the assembly. It may however be that backing plate 10 be surface treated with a photoluminescent material thus negating the requirement for 9.

FIG. 8 shows section B-B through plate 6 in FIG. 7 and illustrates the spigot which mates with slot 11 on the tactile direction indicator 7 extends to the main bore of hole 6b.

FIG. 9 shows section CC through plate 6 in FIG. 6 and illustrates the counterbore on hole 6b.

FIG. 10 shows a typical placement of the tactile guidance doorplate. In this application the tactile guidance doorplate 22 is fixed on a pair of fire doors.

Illustrating a typical example of the use of this present invention, FIG. 8 depicts a part of a building complex. This illustration shows, in plan view, part of a typical hotel corridor and adjoining rooms. Doors 13, 14, 15, 16, 17 and 18 are bedroom doors leading into or out of a bedroom. Doors 21 are fire exit doors and doors 19 and 20 are utility cupboard doors. Within the bedrooms, doors 13a, 14a, 15a, 16a, 17a and 18a are doors from the main area of the room to the en-suite bathroom. Doors 13b, 14b, 15b, 16b, 17b and 18b are wardrobe doors.

In this example we will for illustrative purposes, assume a person is occupying the bedroom accessed by door 14 from the corridor. Again for illustration purposes we will assume that this person is by reason of ambient conditions rendered visually impaired and a situation has arisen whereby that person must navigate from that person's room to the fire exit doors 21.

The first obstacle the person must overcome is to identify the correct door by which to exit the room. In the illustrative example there are doors which will not aid progress toward the fire exit doors 21. These are doors 14a and 14b (being bathroom and wardrobe doors respectively). Fixing a tactile guidance doorplate as depicted in FIG. 1 to the room-side surface of door 14 would enable the person, by tactile interrogation, to identify that door as the correct door through which to exit into the corridor.

In this example, the person would be further assisted if it were made evident upon exiting the room into the corridor, which was the direction to proceed along to the fire exit doors 21. If the tactile guidance doorplate was as shown in FIG. 4, that person would be able to establish by tactile interrogation of the tactile guidance doorplate that not only did it possess raised members 2 but additionally raised member 5 which indicates to the user to proceed to the left after passing through the door.

Since the fire exit doors 21 are the only exit doors, it follows that it is only these doors which have the tactile guidance doorplates fitted on the corridor side. The user therefore can establish by means of tactile interrogation that doors 13, 14, 15, 16, 17 and 18 along the escape route path are not escape path doors.

While the tactile guidance plate has been illustrated for use in a hotel building, it will be appreciated that it may be used in other buildings such as hospitals, offices, public buildings, residential homes, schools and airports or in public transport vehicles such as trains and ships.

As such, an invention has been disclosed in terms of preferred embodiments thereof which fulfil each and every one of the objects of the invention as set forth hereinabove and provide a new and useful door guidance plate for providing directional information of great novelty and utility.

Of course, various changes, modifications and alterations in the teachings of the present invention may be contemplated by those skilled in the art without departing from the intended spirit and scope thereof.

As such, it is intended that the present invention only be limited by the terms of the claims.

1. A tactile guidance device for providing guidance to a person, the device comprising:
a plurality of tactile features for tactile interrogation when in contact with a sensory part of the person;
wherein the tactile features are provided in a first form (2) to identify a passage location through which the person should proceed, and at least one second form (5) to indicate a direction to be followed subsequent to proceeding through said passage.

2. The device according to claim 1 further comprising a plate affixed to a supporting medium.

3. The device according to claim 1 wherein said first form (2) of said tactile features has a rounded outer surface for contact by the person.

4. The device according to claim 3 wherein said tactile features are hemispherical.

5. The device according to claim 1 wherein said at least one second form (5) of said tactile features includes a definable interface between first and second faces.

6. The device according to claim 5 wherein the interface is in the form of a definable edge.

7. The device according to claim 6 wherein a substantially wedge shaped feature is formed via the first face being longer in dimension than the second face.

8. The device according to claim 7 wherein the direction to be followed by the person subsequent to passing through the doorway or passage is indicated by the person contacting the said wedge shaped feature and following the first face in the direction towards the interface.

9. The device according to claim 1 further comprising illumination means (3) to illuminate one or more sections of said device.

10. The device according to claim 1 wherein said first form (2) and said second form (5) of said tactile features are mounted directly on a support medium.

11. The device according to claim 1 wherein said tactile features are mounted on a support medium in a manner that prevents rotational movement of said tactile features during use.

12. A tactile guidance device situated adjacent a passage through which a person is to proceed, the device comprising:
a first tactile form (2) to indicate the presence of the passage and that the user should proceed through the same; and
a second tactile form (5) to indicate the direction to be followed by the person having gone through said passage.

13. The device according to any of the claim 12 further comprising means for distinguishing the tactile features from the adjacent surface.

14. The device according to claim 12 wherein the device is attached to a door which closes the passage through which the device indicates that the person should pass.

15. The device according to claim 12 wherein the device is attached to a support medium adjacent the passage.

16. A tactile guidance device to provide guidance to a person, said device having at least one tactile feature for tactile interrogation when in contact with a sensory part of the person, and said at least one tactile feature is provided in a first form (2) to identify a passage location through which the person should proceed and wherein said device is attached to a door which is positioned at the passage through which the person is indicated to proceed by said first form of tactile features.

17. The device according to claim 16 the device further comprising a second form of at least one tactile feature which indicates a direction to be followed once the person has proceeded through the passage.

18. A method of directing a person by tactile guidance, the method comprising the steps of:
providing a tactile guidance device having a plurality of tactile features for tactile interrogation;
contacting a first form (2) of tactile feature provided to identify a passage through which the person is to move;
contacting at least one second form (5) of tactile feature to indicate a direction to be followed subsequent to passing through said passage;
proceeding through said passage; and
proceeding in a direction as indicated by said at least one second form (2)

19. The method according to claim 18 further comprising the step of indicating the distance to proceed in said direction by the configuration of said at least one second form (5) of said tactile features.

20. The device according to claim 1 wherein the passage is a doorway.

21. The device according to claim 1 further comprising means for distinguishing the tactile features from the adjacent surface.

22. The device according to claim 21 wherein the distinguishing means is raised from the adjacent surface.

23. The device according to claim 21 wherein the distinguishing means is indented into the adjacent surface.

24. The device according to claim 21 wherein the distinguishing means is a hole in the adjacent surface.

25. The device according to claim 1 wherein the device is attached to a door which closes the passage through which the person is indicated to pass by the device.

26. The device according to claim 1 wherein the device is attached to a support medium adjacent the passage.

27. The device according to claim 11 wherein the support medium is a backing plate.

28. The device according to claim 12 wherein the passage is a doorway.

29. The device according to claim 13 wherein the distinguishing means is raised from the adjacent surface.

30. The device according to claim 13 wherein the distinguishing means is indented into the adjacent surface.

31. The device according to claim 13 wherein the distinguishing means is a hole in the adjacent surface.

32. The device according to claim 16 wherein the passage is a doorway.

33. The device according to claim 18 wherein the passage is a doorway.
